(19) United States
(12) Patent Application Publication
(10) Pub. No.: US 2007/0143242 A1
(43) Pub. Date: Jun. 21, 2007

(54) Disk-based cache

(75) Inventors: Patrick C. Miller, Sammamish, WA (US); David R. Quick, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/303,159

(22) Filed: Dec. 15, 2005

(51) Int. Cl. G06F 17/30

(52) U.S. Cl. 707/1

(57) ABSTRACT

An application domain in a front end server processes an object request from a web browser application to determine whether to retrieve the object from a cache on a local disk or from an external database via a back end server. The determination is made by comparing metadata associated with the requested object and object cache settings identified in a configuration file associated with the application domain. The metadata may also identify users who are authorized to access different object versions. An index included in the application domain identifies the objects stored in the cache and the location of the objects on the local disk. When an object is rendered from the database, a determination is made whether to store the object in the cache based on the object cache settings identified in the configuration file. A cache token ensures that the cache remains synchronized with the index.

### BACKGROUND

Internet users expect websites to contain current information that is delivered quickly. When a web page is requested from a client, a server may dynamically render the page to include an object from a database to ensure that the served page contains current information. Alternatively, the object may be retrieved from an output cache at the client. The object may be stored in the output cache if the object was previously requested from the database and the object is considered current. A web page may be rendered faster when an object is retrieved from an output cache rather than the database.

Some object features available on the database are not available when the object is stored locally in the output cache. For example, a security feature that prevents unauthorized user access to objects on the database is not available when the object is stored locally. Similarly, a rights management system offered by the server is not extensible to the output cache. Other database features such as back-up, deployment, approval, and versioning are further unavailable for locally stored objects. Thus, many applications do not take advantage of the time saving feature afforded by output caching.

### SUMMARY

An application domain in a front end server processes an object request from a web browser application to determine whether to retrieve the object from a cache on a local disk or from an external database via a back end server. The determination is made by comparing metadata associated with the requested object and object cache settings identified in a configuration file associated with the application domain. The metadata may also identify users who are authorized to access different object versions. An index included in the application domain identifies the objects stored in the cache, the location of the objects on the local disk, and the amount of space on the local disk occupied by the cached objects. When an object is rendered from the database, a determination is made whether to store the object in the cache based on the object cache settings identified in the configuration file. A cache token ensures that the cache remains synchronized with the index. A change token identifies modifications made to a website such that the cache may be updated to reflect any modifications to the cached objects in the website.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates a computing device in which a disk-based cache application may be implemented.

FIG. 2 is a conceptual diagram illustrating major functional blocks involved in rendering objects on a web page using a disk-based cache.

FIG. 3 illustrates a logic flow diagram for a process of rendering objects on a web page using a disk-based cache.

FIG. 4 illustrates a logic flow diagram for a process of maintaining a current cache.

### DETAILED DESCRIPTION

Embodiments of the present disclosure now will be described more fully hereinafter with reference to the accompanying drawings, which form a part hereof, and which show, by way of illustration, specific exemplary embodiments for practicing the invention. This disclosure may, however, be embodied in many different forms and should not be construed as limited to the embodiments set forth herein; rather, these embodiments are provided so that this disclosure will be thorough and complete, and will fully convey the scope to those skilled in the art. Among other things, the present disclosure may be embodied as methods or devices. Accordingly, the present disclosure may take the form of an entirely hardware embodiment, an entirely software embodiment or an embodiment combining software and hardware aspects. The following detailed description is, therefore, not to be taken in a limiting sense.

### Illustrative Operating Environment

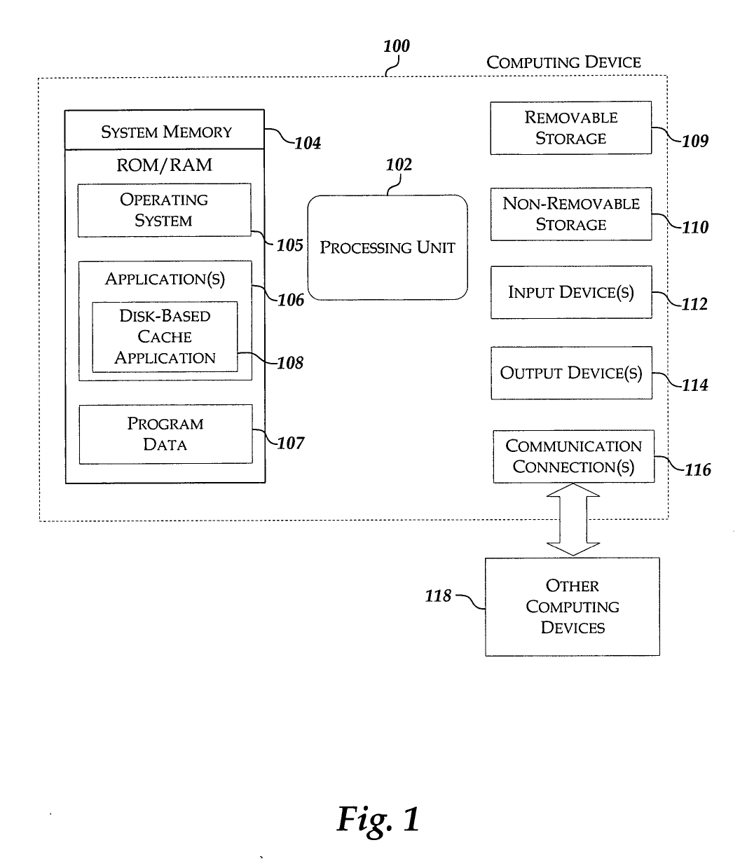

Referring to FIG. 1, an exemplary system for implementing a disk-based cache application includes a computing device, such as computing device 100. In a basic configuration, computing device 100 typically includes at least one processing unit 102 and system memory 104. Depending on the exact configuration and type of computing device, system memory 104 may be volatile (such as RAM), non-volatile (such as ROM, flash memory, and the like) or some combination of the two. System memory 104 typically includes operating system 105, one or more applications 106, and may include program data 107. In one embodiment, applications 106 further include disk-based cache application 108 that is discussed in further detail below.

Computing device 100 may also have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and non-volatile, removable and non-removable media implemented in any method or technology for storage of information, such as computer readable instructions, data structures, program modules or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as a keyboard, mouse, pen, voice input device, touch input device, etc. Output device(s) 114 such as a display, speakers, printer, etc. may also be included. All these devices are known in the art and need not be discussed at length here.

Computing device 100 also contains communication connection(s) 116 that allow the device to communicate with other computing devices 118, such as over a network or a wireless mesh network. Communication connection(s) 116 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

The present disclosure is described in the general context of computer-executable instructions or components, such as software modules, being executed on a computing device. Generally, software modules include routines, programs, objects, components, data structures, and the like that perform particular tasks or implement particular abstract data types. Although described here in terms of computer-executable instructions or components, the present disclosure may equally be implemented using programmatic mechanisms other than software, such as firmware or special purpose logic circuits.

### Disk-Based Cache

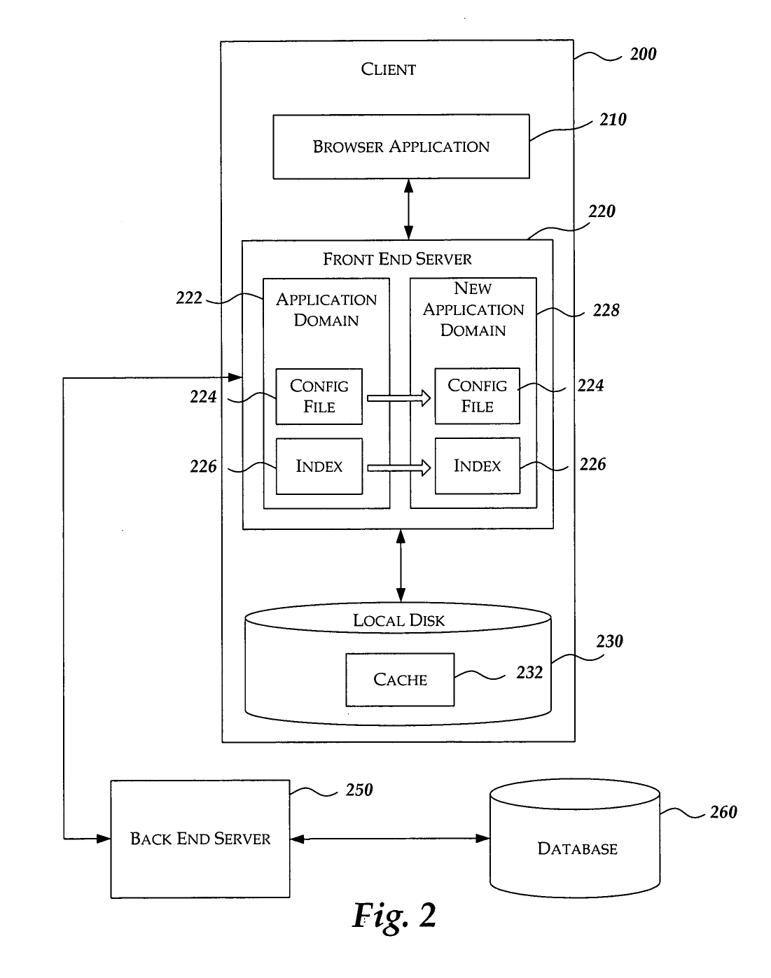

FIG. 2 is a conceptual diagram illustrating major functional blocks involved in rendering objects on a web page using a disk-based cache. Client 200 is coupled to back end server 250, and back end server 250 is coupled to database 260. Client 200 includes browser application 210, front end server 220 and local disk 230. Browser application 210 allows a user to access information on a network such as the Internet. Front end server 220 includes application domain 222. Application domain 222 includes configuration file 224 and index 226. Local disk 230 includes cache 232.

A request for a web page is made from browser application 210. The web page may include at least one object (e.g., filename.jpg). Browser application 210 requests the object from front end server 220 by name. For example, the name may be a uniform resource locator (URL) such as “a/b/filename.jpg”, where “a” and “b” identify subdirectories where the object is stored in a file system. Application domain 222 processes the request to determine whether to retrieve the object from cache 232 or from database 260. In one embodiment, front end server 220 hosts multiple application domains. The different application domains may serve the same website on the same client.

Application domain 220 begins executing when the request for the object is received from browser application 220. Configuration file 224 is referenced to identify settings associated with object caching. Configuration file 224 may identify the objects to be cached. For example, configuration file 224 may identify specific file types that are handled by application domain 222 for caching (e.g., only cache .jpg, .png, .gif, .css and .js files). In another example, configuration file 224 may specify a file path to match such that objects that are retrieved from the specified file path are cached. The file path may be specified using a regular expression. A regular expression provides a “wild card” matching feature such that when a URL is received that matches the regular expression, application domain 222 processes the object associated with the URL. For example, regular expression “/public/images/*01.jpg” causes any .jpg file in the “public/images/” directory with a filename ending in 01 to be cached. Configuration file 224 may identify the location on local disk 230 where the cached objects are stored (e.g., C:/BlobCache). Configuration file 224 may also identify the maximum amount of storage space allocated for output caching on local disk 230. Configuration file 224 may further identify whether output caching is enabled. Some objects are never processed by application domain 222 and are retrieved directly from database 260 via back end server 250. For example, an object located at a URL that contains the expression “. . . /_layouts/ . . . ” is retrieved from back end server 250.

Index 226 provides a management structure for the objects stored in cache 232, information stored on local disk 230, and other data associated with cache 232. For example, index 226 identifies cached objects by name (e.g., URL), the location of the object on local disk 230, and the amount of space on local disk 230 occupied by cache 232. When browser application 210 requests an object, index 226 is referenced to determine whether the object is stored in cache 232.

A requested object is associated with metadata that identifies permissions associated with the web site. The metadata may include an access control list (ACL). An ACL may identify a list of authorized users and the specific rights for each user. An ACL may be associated with a subset of nodes within a website such that the level of access to different areas within the website varies depending on the user. When a node is created in a website, the permission settings associated with the node are inherited from the ACL of a parent node in the website hierarchy.

In one embodiment, an individual object may have a published version, a draft version, a checked-out version, and a visible-to-all version. A published version may be available to all authorized users. A draft version may only be accessed by a select group of authorized users (e.g., an editor). A checked-out version may only be available to the specific user that checked out the object. A visible-to-all version is available to all users. Each version may be identified by the same URL file (e.g., a/b/filename.jpg). Depending on the requesting user, one of the four different object versions may be rendered at the web browser application. The metadata associated with the object identifies the object version that is associated with the requesting user. To simplify processing, only the published version is handled by application domain 222.

Application domain 222 may recycle when domain memory capacity approaches a maximum. When the application domain recycles, front end server 220 generates new application domain 228 while the application domain 222 is still executing. Application domain 222 is discarded when the execution operation is complete. New application domain 228 includes a copy of index 226 from application domain 222 to maintain a one-to-one correspondence between index 226 and cache 232. New application domain 228 references the same configuration file associated with application domain 222 (i.e., configuration file 224). Configuration file 224 allows new application domain 228 to locate cache 232 on local disk 230 and identify individual objects in cache 232. Index 226 is included in new application domain 228 such that cache 232 can survive major computing system failures (e.g., front end server resets, system crashes).

In one embodiment, application domain 222 and new application domain 228 may be executing simultaneously (i.e., after new application domain 228 is created and before application domain 222 is discarded). During this time period each application domain may process different objects such that each index in the application domain is not synchronized with cache 232. For example, application domain 222 may store filename01.jpg in cache 232 while new application domain 228 stores filename02.jpg in cache 232. Thus, cache 232 is no longer synchronous with the indexes in the application domains.

A cache token ensures that cache 232 remains synchronized with the indexes in application domains 222, 228. The cache token is an object created and owned by the operating system. The cache token may be manipulated by a set of application program interfaces. The cache token is accessed when a first user initiates execution of an application domain by accessing an object. The index is owned by the application domain that holds the cache token. A second user may initiate access of a new instance of the same application domain (i.e., the application domain is recycling). The second user attempts to access the cache token associated with the application domain. However, the second user is blocked from accessing the cache token until the executing application domain completes processing of the object and the cache token is released. The cache token permits cross-communication and simultaneous coordination between application domain processes.

In one embodiment, multiple co-existing application domains may reference the same index but only one of the application domains is authorized to write to the index. The other application domains may render the objects that the authorized application domain has previously processed. If the authorized application domain has not processed a requested object, the other application domains retrieve the requested object from the external database via the back end server.

A change token may be used to identify modifications made to a website. Two tokens (token1, token2) may be submitted to a website at different times. Modifications to the website are identified by comparing website data at the time token1 was submitted and at the time token2 was submitted. If the website data is different for each token, a list of the modifications to the website during the established time period is obtained. When a website has been modified, the list of modifications is processed to determine if any objects in cache 232 have been modified. A current change token may be stored in index 226 such that any cached objects associated with the modified website may be identified. Cache 232 is then updated to reflect any modifications to the objects. For example, a file may be deleted from a site. A determination is made that the file is also stored in cache 232. Thus, the file is also removed from cache 232.

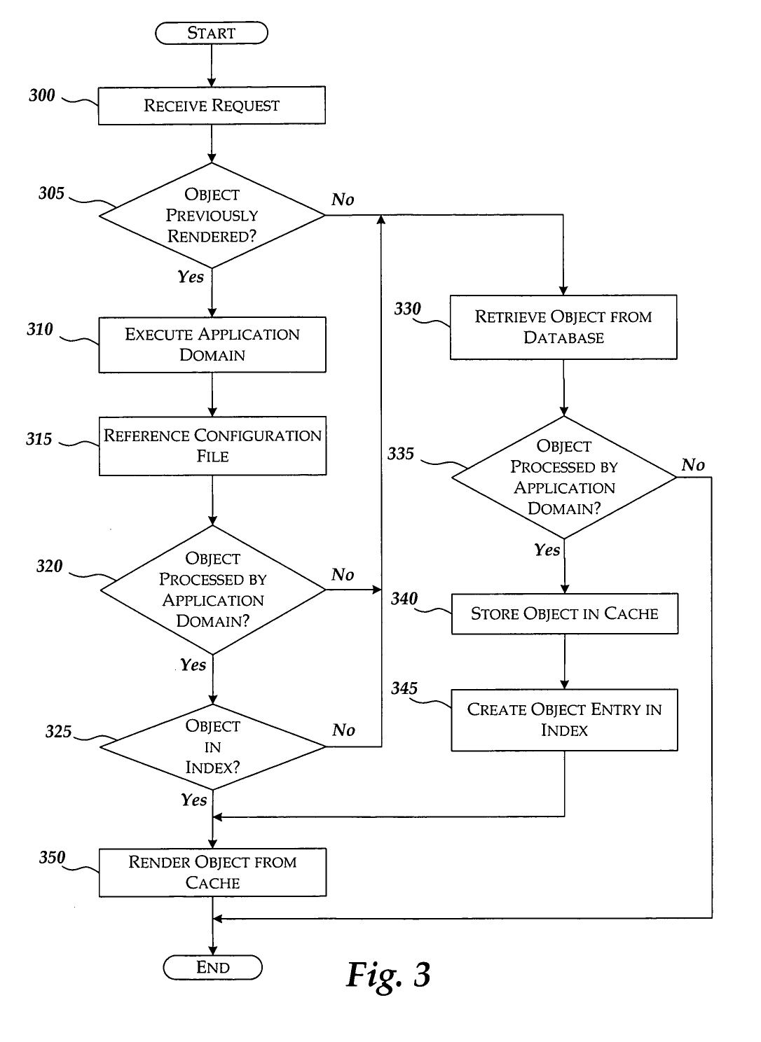

FIG. 3 illustrates a logic flow diagram for a process of rendering objects on a web page using a disk-based cache. The process begins at operation 300 where a request for an object is received from a web browser application. The web browser application requests the object by name from a front end browser. The object may be a file or a link to a file. The request may be a URL that identifies the location of the object. A determination is made at decision operation 305 whether the web browser application has previously rendered the object. If the object has not been previously rendered (i.e., the object is not stored in the cache), processing continues at operation 330. If the web browser application has previously rendered the object, processing moves to operation 310.

An application domain is executed at operation 310. Moving to operation 315, a configuration file is referenced from the application domain to determine whether object caching is enabled and to identify object cache settings. The configuration file identifies the objects to be processed by the application domain. The objects to be processed may be identified by the type of object or the file path of the object. The file path may be specified using a regular expression. The configuration file may also identify the location on a local disk where the cached objects are stored and the amount of space allocated on the local disk for output caching.

Continuing to decision operation 320, a determination is made whether the requested object is processed by the application domain. The determination is made by comparing metadata associated with the requested object and the object cache settings identified in the configuration file. Some objects are never processed by the application domain and are retrieved directly from the database via the back end server. The metadata associated with the object request identifies a list of users who are authorized to access different object versions. The metadata may correspond to an ACL that identifies permission settings associated with a website. The ACL may identify a list of authorized users and the specific rights for each user. Example versions of a requested object include a published version, a draft version, a checked-out version, and a visible-to-all version. Depending on the requesting user, one of the object versions may be rendered. In one embodiment, only the published version of the requested object is processed by the application domain.

In one embodiment, the application domain may be disabled for object caching such that all object requests are processed by the back end server. In another embodiment, the configuration file may identify that the object is not processed by the application domain because the object is not one of the object types identified in the configuration file that the application domain processes. In yet another embodiment, the application domain may not process the object because the object does not correspond to a file path specified in the configuration file. If the object is not processed by the application domain, processing continues at operation 330. If the requested object is processed by the application domain, processing moves to decision operation 325.

Advancing to decision operation 325, a determination is made whether the requested object is included in the index of the application domain. The index provides a management structure for the objects stored in the cache, the information stored on the local disk, and other data associated with the cache. For example, the index identifies each cached object by name (e.g., URL), the location of the object on the local disk, and the amount of local disk space occupied by the cached objects. When the web browser application requests an object, the index is referenced to determine whether the object is stored in the cache. If the object is not included in the index, processing continues at operation 330. If the requested object is included in the index, processing moves to operation 350.

Transitioning to operation 330, the requested object is retrieved from a database via a back end server for rendering at the web browser application. A determination is made at decision operation 335 whether the rendered object is processed by the application domain. The determination is made by comparing metadata associated with the rendered object and the object cache settings identified in the configuration file, as discussed above with reference to decision operation 320. If the rendered object is not processed by the application domain, processing terminates at an end operation. If the rendered object is processed by the application domain, processing moves to operation 340 where a binary equivalent of the rendered object is stored in the cache. Processing then continues at operation 345 where an entry is created in the index that identifies the object that was stored in the cache. The entry identifies the object by name (e.g., URL) and the location of the object on the local disk. Thus, a subsequent request for the rendered object may be processed by the application domain. Processing then continues to operation 350 where the requested object is retrieved from the cache at the identified location on the local disk and rendered at the web browser application. Processing then terminates at the end operation.

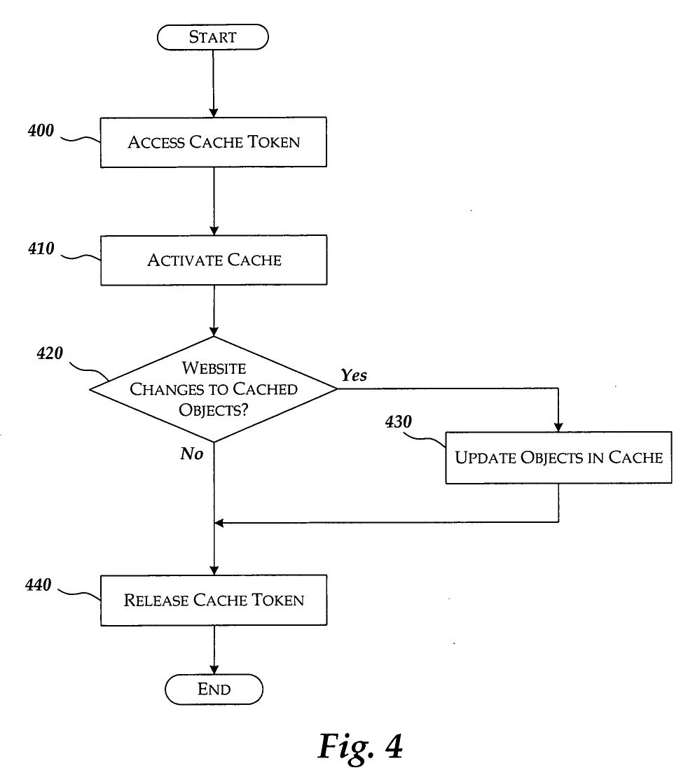

FIG. 4 illustrates a logic flow diagram for a process of maintaining a current cache. The process begins at operation 400 where a cache token is accessed when a user initiates execution of an application domain by accessing an object. The cache token ensures that the cache remains synchronized with an index in the application domain by blocking a subsequent instance of the application domain from processing objects in the cache. In other words, the index is owned by the application domain that holds the cache token. Processing proceeds to operation 410 where the cache is activated.

Moving to decision operation 420, a determination is made whether any changes have been made to a website that includes cached objects. Modifications to a website may be identified by comparing website data at the time a first change token was submitted to the website and at the time a second change token was submitted to the website. If the website data is different for each token, a list of the modifications to the website during the time period between submitted tokens is obtained. When a website has been modified, the list of modifications is processed to determine if any cached objects have been modified. If no change has been made to the cached objects, processing continues to operation 440. If changes have been made to the cached objects, processing continues to operation 430 where the objects are updated in the cache to reflect the modifications.

Processing proceeds to operation 440 where the cache token is released such that a subsequent instance of the application domain may process objects in the cache. The cache token permits cross-communication and simultaneous coordination between application domain processes. Processing then terminates at an end operation.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computer-implemented method for processing a request for an object, comprising:
receiving a request for an object from a web browser application, wherein the request is received at a front end server;
executing an application domain to identify whether the requested object is an object that is processed by the application domain;
referencing an index to determine whether the requested object is stored in a cache when the requested object is processed by the application domain;
retrieving the requested object from the cache when the requested object is stored in the cache; and
rendering the retrieved object at the web browser application.

2. The computer-implemented method of claim 1, wherein the requested object is identified as an object that is processed by the application domain by comparing metadata associated with the requested object and object cache settings identified in a configuration file associated with the application domain.

3. The computer-implemented method of claim 1, further comprising:
retrieving the object from an external database via a back end server when the requested object is not stored in the cache;
storing the object retrieved from the external database in the cache when the object retrieved from the external database is identified as an object that is processed by the application domain; and
updating the index to identify that the object retrieved from the external database is stored in the cache.

4. The computer-implemented method of claim 1, further comprising synchronizing the index with the cache such that the index maintains an accurate listing of objects stored in the cache.

5. The computer-implemented method of claim 1, further comprising updating the cache to reflect a modification made to the object stored in the cache, wherein the object is modified at a website.

6. The computer-implemented method of claim 1, wherein retrieving the requested object further comprises retrieving the requested object from a cache location identified in the index.

7. The computer-implemented method of claim 1, wherein the object is stored in the cache when the application domain previously rendered the object to the web browser application.

8. A system for processing a request for an object, comprising:
a web browser application that is arranged to request an object;
a local disk comprising a cache; and
a front end server coupled to the local disk and comprising an application domain, wherein the front end server is arranged to receive the object request from the web browser application,
wherein the application domain is arranged to:
identify whether the requested object is an object that is processed by the application domain,
reference an index to determine whether the requested object is stored in the cache,
retrieve the requested object from the cache when the requested object is stored in the cache, and
render the retrieved object at the web browser application.

9. The system of claim 8, wherein the requested object is identified as an object that is processed by the application domain by comparing metadata associated with the requested object and object cache settings identified in a configuration file associated with the application domain.

10. The system of claim 8, further comprising:
a back end server coupled to the front end server; and
an external database coupled to the back end server, wherein:
the requested object is retrieved from the external database via the back end server when the requested object is not stored in the cache;
the object retrieved from the external database is stored in the cache when the object retrieved from the external database is identified as an object that is processed by the application domain; and
the index is updated to identify that the object retrieved from the external database is stored in the cache.

11. The system of claim 8, wherein the application domain is further arranged to synchronize the index with the cache such that the index maintains an accurate listing of objects stored in the cache.

12. The system of claim 8, wherein the application domain is further arranged to update the cache to reflect a modification made to the object stored in the cache, and wherein the object is modified at a website.

13. The system of claim 8, wherein the application domain retrieves the requested object from a cache location identified in the index.

14. The system of claim 8, wherein the cache includes the object when the application domain previously rendered the object to the web browser application.

15. A computer-readable medium having computer-executable instructions for processing a request for an object, the instructions comprising:
receiving a request for an object from a web browser application, wherein the request is received at a front end server;
executing an application domain to identify whether the requested object is an object that is processed by the application domain by comparing metadata associated with the requested object and object cache settings identified in a configuration file associated with the application domain;
referencing an index to determine whether the requested object is stored in a cache when the requested object is processed by the application domain;
retrieving the requested object from the cache when the requested object is stored in the cache; and
rendering the retrieved object at the web browser application.

16. The computer-readable medium of claim 15, further comprising:
retrieving the object from an external database via a back end server when the requested object is not stored in the cache;
storing the object retrieved from the external database in the cache when the object retrieved from the external database is identified as an object that is processed by the application domain; and
updating the index to identify that the object retrieved from the external database is stored in the cache.

17. The computer-readable medium of claim 15, further comprising synchronizing the index with the cache such that the index maintains an accurate listing of objects stored in the cache.

18. The computer-readable medium of claim 15, further comprising updating the cache to reflect a modification made to the object stored in the cache, wherein the object is modified at a website.

19. The computer-readable medium of claim 15, wherein retrieving the requested object further comprises retrieving the requested object from a cache location identified in the index.

20. The computer-readable medium of claim 15, wherein the object is stored in the cache when the application domain previously rendered the object to the web browser application.
